(19) United States
(12) Patent Application Publication
(10) Pub. No.: US 2010/0246011 A1
(43) Pub. Date: Sep. 30, 2010

(54) OPTICAL FILM

(75) Inventors: Kazuya Ohishi, Shizuoka (JP); Chikara Murata, Shizuoka (JP); Hideki Moriuchi, Shizuoka (JP); Masaomi Kuwabara, Shizuoka (JP)

Correspondence Address: ARENT FOX LLP, 1050 CONNECTICUT AVENUE, N.W., SUITE 400, WASHINGTON, DC, 20036, US

(73) Assignee: TOMOEGAWA CO., LTD., Tokyo (JP)

(21) Appl. No.: 12/294,840

(22) PCT Filed: Mar. 28, 2007
(86) PCT No.: PCT/JP2007/000315

§ 371 Date: Sep. 26, 2008

(30) Foreign Application Priority Data
Mar. 29, 2006 (JP) 2006-089888

(51) Int. Cl. G02B 1/11

(52) U.S. Cl. 359/580

(57) ABSTRACT

In a composition layering one layer on a transparent substrate, the present invention provides an optical film which can balance anti-glare function, high contrast, color reproducibility, and anti-glittering enough. The optical film in the present invention comprises a transparent substrate, and a resin layer layered on the transparent substrate, the resin layer including transparent resin fine particles and a radiation-curable resin composition, and having a fine rugged structure of an average inclination angle in a range of 0.8° to 3.0° on the top surface of the resin layer; a haze value which is in a range of 40% to 60%; and a transmitted image clarity which is measured by using an optical comb having width of 0.5 mm and is in a range of 5% to 35%.

### TECHNICAL FIELD

The present invention relates to an optical film which is provided on the surface of display devices such as liquid crystal display (LCD), plasma display panel (PDP), etc., and in particular, relates to an optical film used for improving visibility of the screen.

### BACKGROUND ART

In recent years, display devices such as LCD, PDP, etc., have been developed. From cellular phones to large-size televisions, various size products for a lot of usages have been manufactured and sold. In these display devices, in order to improve visibility, the optical films such as low-reflective films, anti-glare films having a low-reflective layer, etc., has been provided on the top surface.

An optical film formed by layering a light diffusion layer having a fine rugged structure on a transparent substrate such as polyethylene terephthalate (PET), triacetylcellulose (TAC), etc., or an optical film formed by layering a low refractive index layer on the light diffusion layer, has been manufactured and sold generally. Optical films providing desired functions by combination of the layer structure have been developed.

In the optical film having only a light diffusion layer on the transparent substrate, image contrast performance is inferior. Therefore, a low refractive index layer in which the refractive index is lower than that of the light diffusion layer is layered on the light diffusion layer, so that image contrast performance has been improved.

Japanese Unexamined Patent Application Publication No. 2002-196117 discloses a method for controlling glittering of a screen. In this method, an average peak-to-valley distance (Sm), an arithmetic mean roughness (Ra), and a ten-point average roughness (Rz) on the surface of the optical film are defined in detail. In addition, Japanese Unexamined Patent Application Publication No. Hei11 (1999)-305010 discloses a method for controlling outside light reflected by the screen, glittering, and white balance. In this method, a range of surface haze and internal haze are defined in detail, and such methods have been developed.

However, an optical film balancing anti-glare function, high contrast, color reproducibility, and anti-glittering has not been obtained. In a composition layering one layer on a transparent substrate, an optical film balancing these characteristics has not been provided.

As a method providing anti-glare function, high contrast, color reproducibility, and anti-glittering respectively, multilayer films and shapes of the film surface has been developed. However, multilayering films require a plurality of coating steps for coating on the transparent substrate, and production costs is high. Furthermore, in the multilayering films, it is difficult to adjust a balance between each layer, and the optical film fulfilling the above-mentioned functions respectively cannot be obtained by an inexpensive means.

### DISCLOSURE OF THE INVENTION

An object of the present invention is to provide an optical film which balances anti-glare function, high contrast, color reproducibility, and anti-glittering enough by a low cost.

An optical film in the present invention comprises a transparent substrate; and a resin layer layered on the transparent substrate, the resin layer including transparent resin fine particles and a radiation-curable resin composition, and having a fine rugged structure of an average inclination angle in a range of 0.8° to 3.0° on the top surface of the resin layer; a haze value which is in a range of 40% to 60%; and a transmitted image clarity which is measured by using an optical comb having width of 0.5 mm and is in a range of 5% to 35%.

In accordance with an aspect of the present invention, the resin layer has an average peak-to-valley distance (Sm) in a range of 50 μm to 200 μm on the top surface thereof.

In accordance with an aspect of the present invention, the resin layer has Macbeth reflection density of 2.7 or more on the top surface thereof.

In accordance with an aspect of the present invention, the resin layer has an arithmetic mean roughness (Ra) in a range of 0.08 μm to 0.25 μm on the top surface thereof.

The optical film in the present invention can balance anti-glare effect, high contrast, color reproducibility, and anti-glittering. When the optical film in the present invention is used for the display surface, display devices can show with high-resolution and good visibility. In addition, production costs can be reduced by decreasing the number of coating steps.

### BEST MODE FOR CARRYING OUT THE INVENTION

As a transparent substrate used for the present invention, glasses such as a fused silica glass, a soda glass, etc., can be used. In addition, various resin films such as PET, TAC, polyethylene naphthalate (PEN), polymethyl methacrylate (PMMA), polycarbonate (PC), polyimide (PI), polyethylene (PE), polypropylene (PP), polyvinyl alcohol (PVA), polyvinyl chloride (PVC), cyclo olefin copolymer (COC), including norbornene resin, polyether sulfone, cellophane, and aromatic polyamide, etc., can be also used as the transparent substrate suitably.

It is preferable that transparency of these transparent substrates is higher. A total light transmittance (JIS K7361-1) is preferably 80% or more, and is more preferably 90% or more. In a viewpoint of lightening, it is preferable that thickness of the transparent substrate is thinner. In consideration of handling when the optical films are manufactured, thickness of the transparent substrate is preferably in a range of 1 μm to 700 μm, more preferably 25 μm to 250 μm.

In addition, the transparent substrate is given the surface treatments such as alkali treatment, corona treatment, plasma treatment, sputter treatment, etc., or is given the coating treatments such as surfactants coating, silane coupling agents coating, etc., or is given the surface modification treatments such as silicon evaporation, etc. As a result, an adhesive performance between the transparent substrate and the resin layer can be improved.

As the radiation-curable resin composition containing in the resin layer used for the present invention, monomer, oligomer, and prepolymer having radical polymerizable functional group such as acryloyl group, methacryloyl group, acryloyl oxy group, methacryloyl oxy group, etc., or having cationic polymerizable functional group such as epoxy group, vinyl ether group, oxetane group, etc., can be used by alone or by mixing suitably. As examples of monomer, it is possible to mention methyl acrylate, methyl methacrylate, methoxy polyethylene methacrylate, cyclohexyl methacrylate, phenoxyethyl methacrylate, ethylene glycol dimethacrylate, dipenta erythritol hexacrylate, trimethylol propane trimethacrylate, etc. As examples of oligomer, prepolymer, it is possible to mention acrylate compounds such as polyester acrylate, polyurethane acrylate, epoxy acrylate, polyether acrylate, alkyd acrylate, melamine acrylate, silicone acrylate, etc., or to mention epoxy compounds such as unsaturated polyester, tetramethylene glycol diglycidyl ether, propylene glycol diglycidyl ether, neopentyl glycol diglycidyl ether, bisphenol A diglycidyl ether, various cycloaliphatic epoxy, etc., or to mention oxetane compounds such as 3-ethyl-3-hydroxylmethyl oxetane, 1,4-bis {[(3-ethyl-3-oxetanyl)methoxy]methyl}benzene, di[1-ethyl(3-oxetanyl)]methyl ether, etc. This radiation-curable resin composition can be used by alone or by mixing a plurality thereof.

The above-mentioned radiation-curable resin composition can cure alone by electron beam irradiation. When the radiation-curable resin composition cures by ultraviolet irradiation, it is necessary to add a photopolymerization initiator. As the photopolymerization initiator, radical polymerization initiators such as acetophenone series, benzophenone series, thioxanthone series, benzoin, benzoin methyl ether, etc., or cationic polymerization initiators such as aromatic diazonium salt, aromatic sulfonium salt, aromatic iodonium salt, metallocene compound, etc., can be used by alone or by combining suitably.

In the present invention, in addition to the above-mentioned radiation-curable resin composition, a polymer resin can be added in the range of not interrupting the polymerization and the curing. This polymer resin is a thermoplastic resin which is soluble in an organic solvent used for the later-describing coating material for the resin layer. Specifically, it is possible to mention acrylic resin, alkyd resin, polyester resin, etc. It is preferable that these resins have acid functional groups such as carboxyl group, phosphate group, sulfonic acid group, etc.

In addition, the resin layer of the present invention can be used additives such as leveling agents, thickening agents, antistatic agents, etc. The leveling agents have functions which evens up a tension on the surface of a coating film, and which corrects the defect before forming the coating film. A material in which both boundary tension and surface tension are lower than that of the above-mentioned radiation-curable resin composition is used as the leveling agent. The thickening agents have a function which gives thixotropy to the above-mentioned radiation-curable resin composition, and can form a fine rugged structure on the surface of the resin layer by preventing sedimentation of transparent resin fine particles, pigments, etc.

The resin layer is mainly composed of a cured material of the above-mentioned radiation-curable resin composition. A forming method for forming the resin layer includes the steps of coating the coating material consisting of the radiation-curable resin composition and the organic solvent, and curing the radiation-curable resin composition by electron beam or ultraviolet irradiation after the organic solvent volatilized. As the organic solvent used here, the suitable one for dissolving the radiation-curable resin composition should be chosen. Specifically, in consideration of the coating aptitude like wet property, viscosity, dry speed, etc., to the transparent substrate, it is possible to use a single solvent or a mixed solvent chosen from alcohol system, ester system, ketone system, ether system, and aromatic hydrocarbon.

Thickness of the resin layer is preferably in a range of 1 μm to 10 μm, preferably 2 μm to 7 μm, and more preferably 3 μm to 6 μm. When the resin layer (hard coating layer) is thinner than 1 μm, a defective curing is caused by oxygen inhibition in ultraviolet irradiation, and the wear resistance of the resin layer is insufficient. When the hard coating layer is thicker than 10 μm, a curl is generated by curing and shrinkage of the resin layer, or micro cracks is generated, or adhesive performance to the transparent substrate is lower, or furthermore light transmission performance is lower. In addition, an amount of the coating material increases according to thickness of the resin layer, so that production costs may be increased.

In the present invention, a fine rugged structure is formed on the surface of the resin layer by scattering the transparent resin fine particles in the resin layer. An average inclination angle on the top surface of the resin layer is in a range of 0.8° to 3.0°, preferably 0.9° to 2.0°, more preferably 0.9° to 1.5°. When the average inclination angle is less than 0.8°, anti-glare effect is insufficient. When the average inclination angle is more than 3.0°, image contrast is insufficient, so that the optical film is unsuitable for using on the display surface.

An average inclination angle θa prescribed in the present invention is calculated according to ISO4287-1984. The shape of the roughened surface is measured at driving speed of 0.03 mm per second by using a surface roughness gauge with stylus probe (trade name: surfcom 570A, a product by Tokyo Seimitsu Co., Ltd.). The inclination line is compensated by subtracting the measured average line, the average inclination angle θa is calculated by the following formulas (1) and (2).

Δa=(1/L)∫₀^{L}f|(d/dx)f(x)|dx (1)

θa=tan⁻¹Δa (2)

As the above-mentioned transparent resin fine particle, it is possible to use an organic transparent resin fine particle which is consisted of acrylic resin, polystyrene resin, styrene acrylic copolymer, polyethylene resin, epoxy resin, silicone resin, polyvinylidene fluoride, or polyethylene fluoride, etc. A refractive index of the transparent resin fine particle is preferably in a range of 1.40 to 1.75. When the refractive index is less than 1.40 or more than 1.75, a difference of refractive indexes between the transparent resin fine particle and the transparent substrate or the resin layer is too big, so that the total light transmittance decreases. A particle size of the transparent resin fine particle is preferably in a range of 0.3 μm to 10 μm, more preferably 1 μm to 5 μm. When the particle size is 0.3 μm or less, it is not desired because anti-glare effect is lower. When the particle size is 10 μm or more, it is not desired because glare is generated and a rugged level on the surface is too big and the surface of the resin layer becomes whity.

A transmitted image clarity of the optical film in the present invention is a value measured by using an optical comb having width of 0.5 mm according to JIS K7105. Specifically, transmission light passing through a sample or reflection light reflected by a sample is measured via a moving optical comb by using a transmitted image clarity measurement apparatus, and the transmitted image clarity is calculated.

In the present invention, the transmitted image clarity using an optical comb having width of 0.5 mm should be in a range of 5% to 35%, preferably 20% to 35%. When the transmitted image clarity is less than 5%, image contrast and color reproducibility is insufficient. When the transmitted image clarity is more than 35%, anti-glare effect is insufficient, so that the optical film is unsuitable for using on the display surface.

A haze value of the optical film in the present invention, the value which is measured according to JIS K7136, is in a range of 40% to 60%. When the transmitted image clarity and the average inclination angle is in a range prescribed in the present invention, and when the haze value is less than 40%, neither anti-glare effect nor anti-glittering effect are obtained enough. When the haze value is more than 60%, image contrast is lower, and display quality is lower, so that the optical film is unsuitable for using on the display surface.

The above-mentioned average inclination angle, the transmitted image clarity, and the haze value can be controlled in the desired range by adjusting an addition amount of filler, scattering condition of filler, and thickness of the resin layer. Specifically, when the addition amount of filler increases, the filling amount of filler per unit volume increases, and the rugged structure is easily formed on the surface of the resin layer by filler. Therefore, the average inclination angle enlarges, the transmitted image clarity is lower, and the haze value rises. When filler is scattered in a condition in which a part of filler in the resin layer condenses, the rugged structure is easily formed on the surface of the resin layer by compact clusters of filler. Therefore, the average inclination angle enlarges, the transmitted image clarity is lower, and the haze value rises. When thickness of the resin layer is thinner, the rugged structure is easily formed on the surface of the resin layer by filler. As a result, the average inclination angle enlarges, and the transmitted image clarity is lower.

An average peak-to-valley distance (Sm) of the optical film in the present invention is a value measured according to JIS B0601. Specifically, only a standard length is specified from a roughness curve in the direction of the average line. In this specified part, the sum of length of the average line between one peak and one valley adjacent to the peak (hereinafter, it is said “peak-to-valley distance”) is calculated. Sm is an arithmetic mean value of these many peak-to-valley distances, and is expressed by millimeter (mm).

In the present invention, Sm is preferably in a range of 50 μm to 200 μm. When Sm is less than 50 μm, image contrast is not obtained enough. When Sm is more than 200 μm, anti-glare effect is lower, so that the optical film is unsuitable for using on the display surface. The average inclination angle can be easily adjusted in a range of 0.8° to 3.0° by adjusting Sm in a range of 50 μm to 200 μm.

Macbeth reflection density of the optical film in the present invention is preferably 2.7 or more, when it is measured in a condition in which an opposite side of the resin layer is black. When the optical film is used for the display surface, etc., a big difference in displaying white color is few. Therefore, it is necessary to emphasize black color in order to control in high contrast. When Macbeth reflection density is less than 2.6, high contrast is not obtained enough.

An arithmetic mean roughness (Ra) of the optical film in the present invention is a value measured according to JIS B0601. Specifically, only a standard length is specified from a roughness curve in the direction of the average line. When the direction of the average line in the specified part is assumed to be X-axis and the direction of axial magnification is assumed to be Y-axis, the roughness curve is shown with y=f(x). The arithmetic mean roughness (Ra) is calculated by the following formula (3), and shown by micrometer (μm).

Ra=(1/L)∫₀^{L}|f(x)|dx (3)

In the present invention, Ra is preferably in a range of 0.08 μm to 0.25 μm. When Ra is less than 0.08 μm, anti-glare effect is not obtained enough. When Ra is more than 0.25 μm, image contrast is lower. Therefore, the optical film is unsuitable for using on the display surface. The average inclination angle can be easily adjusted in a range of 0.8° to 3.0° by adjusting Ra in a range of 0.08 μm to 0.25 μm.

There is especially no limitation in a forming method for forming the resin layer on the transparent substrate. The forming method comprises the steps of coating a coating material including the transparent resin fine particle and the radiation-curable resin composition on the transparent substrate, and curing the radiation-curable resin composition after the coating material dried. As a result, the resin layer having a fine rugged structure on the surface is formed. As a method for coating a coating material on the transparent substrate, usual coating methods or printing methods is applied. Specifically, the coating methods such as air doctor coating, bar coating, blade coating, knife coating, reverse coating, transfer roll coating, gravure roll coating, kiss coating, cast coating, spray coating, slot orifice coating, calendar coating, dam coating, dip coating, die coating, or the printing methods such as intaglio printing like gravure printing, or stencil printing like screen printing, can be used.

A ratio of the transparent resin fine particles included in the above-mentioned coating material is not especially limited. In order to fulfill the optical characteristics such as anti-glare effect, anti-glittering, etc., a ratio of the transparent resin fine particles is preferably in a range of 1 to 20 parts by weight of the transparent resin fine particles per 100 parts by weight of the resin. As a result, the fine rugged structure on the surface of the resin layer, and the haze value can be controlled easily.

### EXAMPLES

Examples in the present invention and Comparative Examples will be explained as follows. The term of “parts” always means “parts by weight”.

### Example 1

A coating material for the resin layer was prepared by distributing a mixture consisted of the following coating elements for 30 minutes in the sand mill. The coating material was coated on one side of the transparent substrate consisted of TAC having thickness of 80 μm and the total light transmittance of 92% by a reverse coating method. The coated film was dried for one minute at 100° C., and was irradiated ultraviolet ray by using a high-pressure mercury lamp concentrated light with energy of 120 W/cm in the nitrogen atmosphere (irradiation distance: 10 cm, exposure time: 30 seconds). Then, the coated film was cured.

The coating elements for the resin layer were composed of:

25.44 parts of pentaerythritol triacrylate (trade name: PE3A, a product by Kyoeisha Chemical Co., Ltd.),

10.9 parts of urethane acrylate (trade name: beam set 575BT, a product by Arakawa Chemical Industries, Ltd.),

1.91 parts of photopolymerization Initiator (trade name: Irgacure 184, a product by Ciba Specialty Chemicals Inc.),

0.22 parts of leveling agent (trade name: Megafakku F471, a product by Dainippon Ink Chemical Industry Corp.),

5.63 parts of crosslinked polystyrene beads having particle diameter of 3.5 μm (trade name: SH350H, a product by Soken Chemical & Engineering Co., Ltd.),

0.9 parts of thickening agent (trade name: Rusentite SAN, a product by Coop Chemical Co., Ltd.), and

55 parts of toluene.

Thus, an optical film having a roughened surface layer in which thickness is 5.5 μm and the haze value is 47% was prepared.

### Comparative Example 1

The coating elements for the resin layer were similar to Example 1 except to change as follows. The coating elements for the resin layer were composed of:

45.89 parts of epoxy-acrylate system UV resin having a solid ratio of 85% in the solution (trade name: KR-584, a product by ADEKA Corporation.),

7.05 parts of crosslinked polystyrene beads having a particle diameter of 3.5 μm (trade name: SH350H, a product by Soken Chemical & Engineering Co., Ltd.),

0.94 parts of cellulose acetate butyrate (trade name: CAB381-2, a product by Eastman Chemical Co., Ltd.),

40.82 parts of methyl isobutyl ketone, and

5.3 parts of cyclohexanone.

Thus, an optical film having a roughened surface layer in which thickness is 2.7 μm and the haze value is 44.4% was prepared.

### Comparative Example 2

The coating elements for the resin layer were similar to Example 1 except to change as follows. The coating elements for the resin layer were composed of:

58.2 parts of epoxy-acrylate system UV resin having a solid ratio of 85% in the solution (trade name: KR-584, a product by ADEKA Corporation.),

5.5 parts of crosslinked polystyrene beads having a particle diameter of 3.5 μm (trade name: SH350H, a product by Soken Chemical & Engineering Co., Ltd.),

31.8 parts of methyl isobutyl ketone, and

4.5 parts cyclohexanone.

Thus, an optical film having a roughened surface layer in which thickness is 4.3 μm and the haze value is 31.1% was prepared.

By using the optical films prepared for the Example 1, Comparative Examples 1 and 2, the number of transparent resin fine particles per unit area, the haze value, the total light transmittance, the transmitted image clarity, the average inclination angle, Ra, Sm, Macbeth reflection density, anti-glare effect, image contrast, color reproducibility, and glittering were measured and were evaluated by the following method.

The haze value was measured by using a haze meter (trade name: NDH 2000, a product by Nippon Denshoku Industries Co., Ltd.) according to JIS K7136.

The total light transmittance was measured by using the above-mentioned haze meter according to JIS K7361-1.

The transmitted image clarity was measured by using a image clarity meter (trade name: ICM-1DP, a product by Suga Test Instruments Co., Ltd.) in which measurement mode is set in transmission mode and in which width of the optical comb is 0.5 mm according to JIS K7105.

The average inclination angle θa was calculated by the following formula, after Δa (average inclination) was measured by using a surface roughness gauge with stylus probe (trade name: surfcom 570A, a product by Tokyo Seimitsu Co., Ltd.) according to ISO 4287/1-1984. The average inclination angle θa=tan⁻¹(Δa).

Ra and Sm were measured by using the above-mentioned surface roughness gauge according to JIS B0601-1994.

Macbeth reflection density on the surface of the resin layer was measured by using Macbeth reflection density meter (trade name: RD-914, a product by Sakata Engineering Co., Ltd.), after opposite side of the resin layer in the optical films of Example 1, Comparative Examples 1 and 2 was painted black by Magic Ink (registered trade mark).

Anti-glare effect was evaluated as follows. After the optical films of Example 1, Comparative Examples 1 and 2 were adhered to the screen surface of liquid crystal TV (trade name: Aquos LG-32GD4, a product by SHARP Corporation.) via the adhesion layer, the liquid crystal TV turned light off. Then, under an illumination intensity of 250 lx, any 100 persons visually evaluated the presence of own image (own face) reflected by the screen at 50 cm vertically away from the center of the screen surface. When a person who did not feel the reflection was 70 people or more, the evaluation was assumed to be “good”. When a person who did not feel the reflection was 30 people or more and less than 70 people, the evaluation was assumed to be “average”. When persons who did not feel the reflection were less than 30 people, the evaluation was assumed to be “poor”.

Image contrast was evaluated as follows. After the optical films of Example 1, Comparative Examples 1 and 2, and a non-glare film for comparison (trade name: sunfilter NF, a product by SUNCREST Co., Ltd.) were adhered to the screen surface of liquid crystal TV (trade name: Aquos LG-32GD4, a product by SHARP Corporation.) via the adhesion layer, the liquid crystal display turned light off. Then, under an illumination intensity of 250 lx, any 100 persons visually evaluated the blackness at 50 cm vertically away from the center of the screen surface. When a person who felt that the screen of the optical film are more black than the screen of the non-glare film was 70 people or more, the evaluation was assumed to be “good”. When a person who felt that the screen of the optical film are more black than the screen of the non-glare film was 30 people or more and less than 70 people, the evaluation was assumed to be “average”. When a person who felt that the screen of the optical film are more black than the screen of the non-glare film was less than 30 people, the evaluation was assumed to be “poor”.

Color reproducibility was evaluated as follows. After the optical films of Example 1, Comparative Examples 1 and 2 were adhered to the screen surface of liquid crystal TV (trade name: Aquos LG-32GD4, a product by SHARP Corporation.) via the adhesion layer, the liquid crystal display turned pink light on. Then, under an illumination intensity of 250 lx, any 100 persons visually evaluated a color difference between viewing at 50 cm vertically away from the center of the screen surface and viewing at the viewing angle of 45° to the center of the screen surface. When a person who did not feel a color difference between viewing at the vertical direction and viewing at the 45° direction was 70 people or more, the evaluation was assumed to be “good”. When a person who did not feel a color difference between viewing at the vertical direction and viewing at the 45° direction was 30 people or more and less than 70 people, the evaluation was assumed to be “average”. When a person who did not feel a color difference between viewing at the vertical direction and viewing at the 45° direction was less than 30 people, the evaluation was assumed to be “poor”.

Glittering was evaluated as follows. After the optical films of Example 1, Comparative Examples 1 and 2 were adhered to the screen surface of liquid crystal monitor (trade name: LL-T1620-B, a product by SHARP Corporation.) via the adhesion layer, the liquid crystal display turned green light on. Then, under an illumination intensity of 250 lx, any 100 persons visually evaluated the presence of glittering at 50 cm vertically away from the center of the screen surface. When a person did not feel glittering was 70 people or more, the evaluation was assumed to be “good”. When a person did not feel glittering was 30 people or more and less than 70 people, the evaluation was assumed to be “average”. When persons did not feel glittering were less than 30 people, the evaluation was assumed to be “poor”.

Table. 1 shows evaluation results according to the above-mentioned evaluation method.

TABLE 1

| | | Total | Transmitted | Average | | | Macbeth | | | | |
|---|---|---|---|---|---|---|---|---|---|---|---|
| | Haze | light | image | inclination | | | reflection | Anti- | Image | Color | |
| | value | transmittance | clarity | angle | Ra | Sm | density | glare | contrast | reproducebility | Glittering |
| Example 1 | 47.7 | 93.0 | 16.6 | 1.15 | 0.16 | 122 | 2.84 | good | good | good | good |
| Comparative 1 | 44.4 | 92.7 | 37.3 | 1.26 | 0.20 | 220 | 3.04 | average | good | good | average |
| Comparative 2 | 31.1 | 91.7 | 26.9 | 0.92 | 0.18 | 317 | 2.83 | average | good | good | average |

The optical film of Example 1 balanced anti-glare effect, high contrast, color reproducibility, and anti-glittering enough. The optical film of Comparative Example 1 in which the transmitted image clarity was more than 35, and the optical film of Comparative Example 2 in which the haze value was less than 40 and Sm was more than 200, cannot fulfill anti-glare effect and glittering together.

1. An optical film comprising:
a transparent substrate;
a resin layer layered on the transparent substrate, the resin layer including transparent resin fine particles and a radiation-curable resin composition, and having a fine rugged structure of an average inclination angle in a range of 0.8° to 3.0° on the top surface of the resin layer;
a haze value which is in a range of 40% to 60%; and
a transmitted image clarity which is measured by using an optical comb having width of 0.5 mm and is in a range of 5% to 35%.

2. The optical film according to claim 1, wherein the resin layer has an average peak-to-valley distance (Sm) in a range of 50 μm to 200 μm on the top surface thereof.

3. The optical film according to claim 1, wherein the resin layer has Macbeth reflection density of 2.7 or more on the top surface thereof.

4. The optical film according to claim 1, wherein the resin layer has an arithmetic mean roughness (Ra) in a range of 0.08 μm to 0.25 μm on the top surface thereof.
